(19) United States
(12) Patent Application Publication
(10) Pub. No.: US 2009/0204490 A1
(43) Pub. Date: Aug. 13, 2009

(54) Online professional development system and virtual manager for performance artists

(75) Inventors: Daniel Gerard Squillace, Deerfield Beach, FL (US); Shane Andrew McKinney, Lake Worth, FL (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Music Innovations International, LLC, Fort Lauderdale, FL (US)

(21) Appl. No.: 12/069,790

(22) Filed: Feb. 13, 2008

(51) Int. Cl. G06Q 30/00

(52) U.S. Cl. 705/14

(57) ABSTRACT

A system for online artist promotion comprises an artist interface, a broadcast application, an industry interface and a virtual manager. The artist interface allows artist to input artist histories and artist biographies, and to upload multimedia performances. The broadcast application allows the system to broadcast the multimedia performances. The industry interface allows industry professionals to input service provider information. The virtual manager guides the artist through development steps as a function of the artist history, and links the artists with the industry professionals as a function of the development steps and the service provider information.

### BACKGROUND OF THE INVENTION

This invention relates generally to artist development, and specifically to an online system for promoting musicians and other performance artists. In particular, the system is directed toward web-based tools for professional artistic development, including a virtual manager to help performance artists navigate important career milestones, and an online artist community that partners the artists with industry professionals to help achieve the milestones. The virtual manager is non-linear, in order to provide individualized pathways for artists with different professional histories and different career aspirations.

As musical artists and other performance artists advance professionally, they rely more and more upon industry professionals to help achieve career milestones. These milestones include producing audio and visual recordings of their artistic works, booking paid gigs and other performance or show venues, building artist biographies and other marketing tools, and entering into long-term performance and recording deals.

Most artists are fully aware of these important milestones, but simply do not have the expertise (and time) required to work through the details required to achieve them. Performing artists thus require a wide range of professional industry services, including studio engineering and other multimedia production services, as scheduling, transportation, and other hands-on performance management services, and a range of broader professional support services including marketing and market development, accounting services, and legal services for contract review, business incorporation, and dispute resolution.

As artists grow and mature, they also span a continuum of experience levels, ranging from garage bands, street rappers and other startups to full-time concert performers and other artistic enterprises that require full-service agents and full-time marketing and production assistance. Each artist, finally, brings a unique mix of skills and experiences to the industry, and each seeks a particular set of career goals, which may or may not be the same as those of artists in other genres, or even with the particular goals of other artists in the same genre.

On the industry end, it is notoriously difficult to identify, recruit, and successfully develop marketable artistic talent. In addition, existing business models that are appropriate for paying industry professionals, such as promoters and recording companies, are not always appropriate for fee-for-service industry professionals, such as photographers, recording technicians, agents, and studio musicians. All of the players, moreover, including artists, moguls, and accountants, have a continuing need to develop new markets for their products and services.

There remains an ongoing need, therefore, for a more flexible and comprehensive approach to professional development for performing artists. In particular, there remains a need for professional development tools that provide individualized career guidance to musicians and other performing artists. There is also a need to provide this guidance within a widely accessible artist community that fosters productive relationships with industry professionals, who can provide the right level of service at the right cost, and can help the artists achieve success on the their own individual terms.

### BRIEF SUMMARY OF THE INVENTION

This invention relates to an online system for artist promotion and professional development. The system comprises an artist interface, a provider interface, a multimedia scrolling application for audio/visual performances and biographical data, and a non-linear navigational tool for personalized professional development.

The artist interface allows artists to upload audio-visual artworks and biographical data, and the multimedia scrolling application reproduces the audio-visual artworks online, in combination with the biographical data. The artist interface also allows artists to input individual preferences regarding professional milestones, and the provider interface allows artistic industry professionals to offer related services, in order to help the artists achieve the professional milestones. The non-linear navigational tool guides the artists toward the professional milestones as a function of the individual preferences, and links the artists to the industry professionals that offer the related services.

### BRIEF DESCRIPTION OF THE DRAWINGS

FIG. 1 is a schematic illustration of an online system for artist promotion and professional development.

FIG. 2 is a schematic illustration showing a non-linear professional development tool or “virtual manager” for the system of FIG. 1.

FIG. 3 is a schematic illustration showing an online studio and multimedia/artist biography broadcast application for the system of FIG. 1.

FIG. 4 is a schematic illustration showing a premium service feature for the system of FIG. 1.

### DETAILED DESCRIPTION

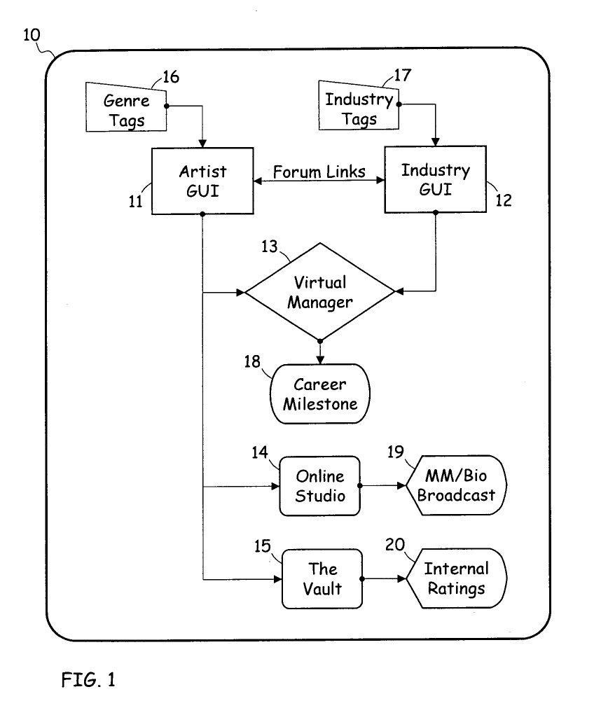

FIG. 1 is schematic illustration of online system 10 for online artist promotion and professional development. System 10 comprises artist interface 11, provider interface 12, non-linear professional development tool (“Virtual Manager”) 13, online studio 14 and premium service feature (“The Vault”) 15.

System 10 provides a widely-accessible artist community that brings performing artists and industry professionals together, in order to help the artists attain important career milestones. System 10 also provides individualized professional development tools, in order to help guide the artists down the steps necessary to achieve these milestones, and achieve particular levels of professional success that are individually defined according to each artist's unique history and career goals.

In some embodiments, system 10 comprises a website, the community comprises an online artist community for performing artists and industry professionals, and the professional development tools comprise non-linear navigational tools to guide the artists through professional development steps related to individualized career milestones. In these embodiments system 10 provides wide access to the community and the professional development tools via a set of URLs (uniform resource locators), which are associated with the website. In one particular embodiment, the set of URLs comprises a particular URL identified as www.promotemysong.com, but in other embodiments the set of URLs varies.

In typical embodiments, wide access to the community and professional development tools is also provided by a combination of URLs and other internet-based or world wide web-based (www-based) means of communication, including email and other text communications, audio communications, and audio-video and other multimedia forms of internet-based communication. Additional access is provided by telephone-based means of communication, including phone-based and PDA-based (personal digital assistant-based) text, audio, and multimedia communications. Community access is also provided via personal contacts including direct face-to-face contact, particularly for professional relationships between artists and industry professionals, and for users selecting preferred levels of service, as described below.

Artist interface (or user interface) 11 is a graphical user interface (GUI) that provides artist access to system 10. Artist GUI 11 is an online application, providing graphical, text, audio-visual and other multimedia access to website 10 over the internet or world-wide web (www). The access comprises two-way communications including, but not limited to, upload, data input, download, data output and data streaming. In one embodiment, access is provided via a specific set of URLs, and in other embodiments access is provided by a combination of URLs and other internet, phone, and direct personal means of communication, as described above.

Artist interface 11 provides online access to a range of different artist entities including individual artists, groups, bands, symphonies, ensembles, troupes, companies, casts, and other artist groups. The artists are typically performance artists, including, but not limited to, musicians, singers, singer-songwriters, rappers, actors, dancers and other performance artists. Alternatively, the artists include non-performance-based artists, such as set designers, makeup or costume artists, or other industry professionals that identify themselves as artists.

Artist users typically perform in live gigs and shows, and also produce music videos, dance videos and other audio-visual or multimedia products. In alternate embodiments the users seek access to a more generalized online community for education and other forms of professional development.

Each artist or user selects one or more genre tags 16. Typically, genre tags are self selected, but some users select genre tags via virtual manager 13. Musical genre tags 16 include, but are not limited to, Acoustic, Alternative, Ambiance, Blue Grass, Blues, Celtic, Christian, Christian Rap, Christian Rock, Classical, Country, Covers Only, Death Metal, Electronic, European, Folk, Folk Rock, Freestyle, Funk, Garage Band, Gospel, Gothic, Grunge, Hard Rock, Hardcore, Hip Hop, Horrorcore, House, Indie, Industrial, Jazz, Latin, Latin Rock, Metal, New Instrument, Polk Country, Pop, Punk, Rap, Reggae, Rhythm and Blues (R&B), Rock, Soca, Soul, Underground and World. Music-related genre tags include, but are not limited to, Musicals, Broadway Shows, BURLesque, Circus, Acrobatics, Ballet, Modern Dance, Drama, Poetry, Comedy, Period Music, Renaissance Music, Civil War Music, Musical Reenactment, Drama, Reality-based Theater, Street Theater, Street Rap, Comedy, Magic, Acrobatics, Circus Performance, and Performance Art. General user tags describe other types of users, including, but not limited to, industry professionals included in one or more of industry tags 17, as described below.

Artist GUI 11 allows artists to enter artist input into system 10, including personal information and biographical data. The personal information includes names, addresses, phone number and other contact information. Some artists also include payment information for access to premium service feature (or premium service application) 15, or for use by industry professionals with whom the artist enters into business relationships.

The biographical data include professional biographical information such as experience, training and awards. The biographical data vary substantially from artist to artist; some artists, for example, choose to include more personal biographical information such as place and date of birth, hobbies, family information, and personal trivia. Other artists choose to provide less personal biographical information, or to provide marketing-based personal information such as a stage name or marketing-based biographical information.

Artist GUI 11 also allows the artists to upload multimedia performances, including music or dance videos, rap or poetry readings, demo videos, movie clips, staged performances, concert performances, and other multimedia recorded performances. Together with the other artist input, the multimedia performances display the artists' talents in order to help them market live performances or songs, videos and other performance-related products. The live performances, for example, comprise live renditions of the multimedia performance, while the songs comprise musical recordings of the multimedia performance.

Artist GUI 11 also allows the artists to receive output from system 10. The output includes industry information such as business contact and service provider information, as obtained via industry GUI 12. Artist GUI also allows artists to interact with virtual manager 13, and receive premium-service based information from premium service feature 15, as described below.

Industry interface (or provider interface) 12 is a graphical user interface (GUI) providing access to system 10 for industry professionals. Similarly to artist GUI 11, industry GUI 12 provides graphical, text, audio-visual and other multimedia access to website 10, including, but not limited to, upload (input), download (output) and streaming capabilities. Access is typically provided via the same set of URLs utilized by artist GUI 11, and as associated with website 10, ad via the other means of communication described above.

Industry GUI 12 provides input and output functionality analogous to that of artist GUI 11. There are, however, a number of distinctions related to the different needs of users (artists) with particular professional goals, and industry professionals (service providers) who help the user achieve those goals.

Industry professionals include both traditional fee-for-industry professionals, such as photographers and video production, and paying providers, such as recording studios, promoters, and industry moguls. Industry professionals select one or more industry tags 17, including, but not limited to, Booking Agents, Concert Security, Digital Distribution, Distributors, Graphic Art and Design, Instrument Rentals, Instrument Repairs, Instrument Sales, Managers, Mastering, Mastering Licensing, Merchandise, Mobile Recording, Music Licensing, Music Publishing, Music Schools, Photographers, Print Publications, Production Companies, Promoters, Publicists, Record Labels, Recording Studios, Sound Reinforcement, Street Teams, Venues, and Video Production.

Industry GUI 12 allows industry professionals to enter industry input and service provider information including business name and contact information. Like artist information, provider information varies substantially among individual industry professionals. In particular, some industry professionals provide publicly listed contact information, while others provide privately listed information that is restricted to premium subscribers, as described below. In addition, some industry professionals provide geographical information, industry experience and pricing information, while others reserve this information until they make private contact with particular artists or users.

Industry GUI 12 also allows industry professionals to upload multimedia commercial works, including advertisements and how-to videos. The industry input and multimedia works describe the services provided by the industry professionals, and how these services can help each individual artist reach particular professional milestones and career goals. In particular, the industry input allows artists to choose from among the most appropriate service providers based on experience, rates, geography, and other relevant industry input and service provider information.

Industry GUI 12 also allows industry professionals to receive output from system 10. In particular, the output includes contact information for artists (or members of the general public) who require particular industry services. Some of this output is publicly available, and some is privately available via virtual manager 14. Industry GUI 12 also allows industry professionals to interact with virtual manager 13 and to obtain premium-subscriber based information from premium service feature 15.

Virtual manager 13 is a non-linear professional development tool designed to help artists or other general-purpose users reach particular professional milestones 18. Virtual manager 13 allows artists to provide input related to professional milestones 18, including individual artist history and career goals.

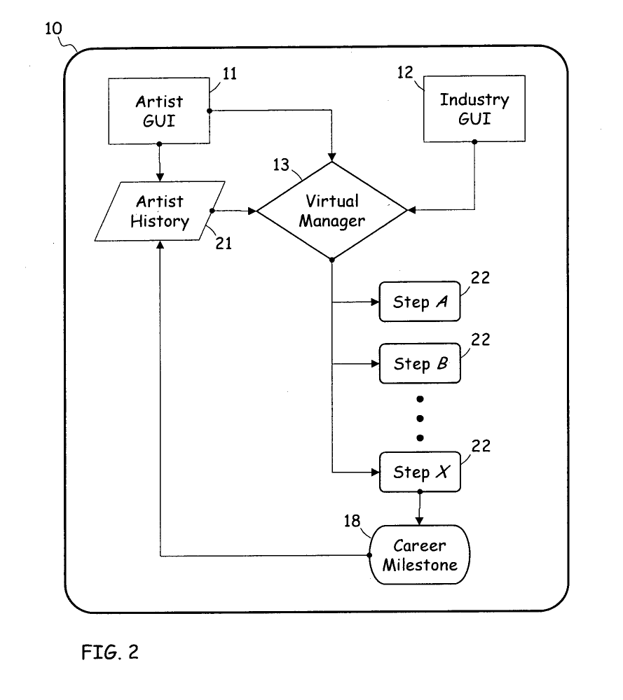

Virtual manager 13 suggests intermediate steps related to the milestones, and links the artists to specific industry providers that can help guide them through these steps (along a particular career path), in order achieve the milestones. In some cases the career goals (or professional goals) correspond to the professional milestones, and in other cases the professional milestones are somewhat different from the career goals. Other aspects of virtual manager 13 are discussed in more detail with respect to FIG. 2, below.

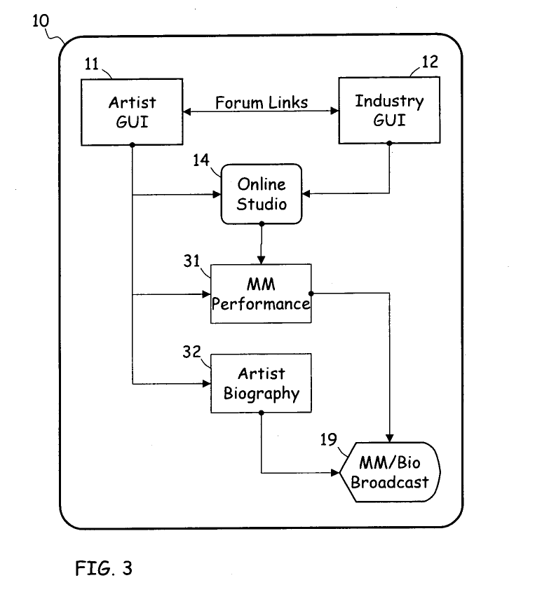

Online studio 14 is available to produce multimedia performance for multimedia/bio broadcast application 19. Broadcast application (or broadcaster) 19 streams the multimedia performance in one window, while scrolling the artist's biography in another window. The functions of online studio 14 and broadcast application 19 are described in more detail with respect to FIG. 3, below.

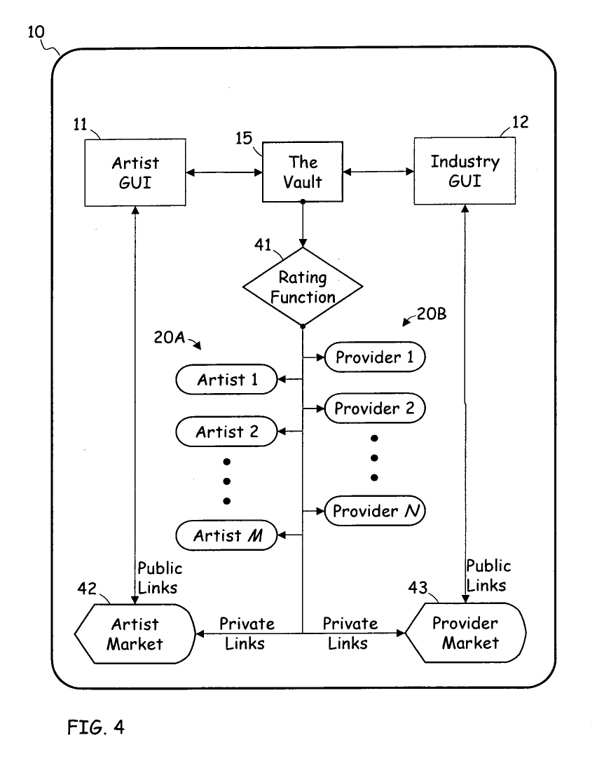

Some artists elect to receive premium services from “The Vault” or other premium service feature 15. Premium service feature 15 enhances the functionality of virtual manager 13, by providing hand-picked internal ratings 20 and providing access to non-publicly listed service providers who prefer to work with these hand-picked artists. Premium service feature 15 also allows virtual manager 13 to provide specific goal-based and milestone-based professional advice from moguls, mentors and other industry professionals with substantial genre-specific experience. Premium service feature 15 is described in more detail with respect to FIG. 4, below.

In general operation, system 10 provides an internet-based community for performing artists and industry professionals, through a series of public and private forum links between artist GUI 11 and industry GUI 12. These public links allow each member of the community (that is, each user or service provider) to learn about and communicate with other community members, regardless of genre, user/provider distinction, or whether the members enter into professional relationships or not.

Specifically, the forum links include public (open market) links, such artist directories sorted by artist genre 16 and industry professional directories sorted by industry tag 17. The public links provide access to artist information and multimedia performances, and to industry information and commercial (advertising) works.

Typically, public forum links are also available to non-artist, non-professional members of the general audience, including fans and other consumers of music and performance-related products. Thus the public forum links provide artists and industry professionals with broad access to public markets, including artist markets, industry professional markets, and non-user, non-professional consumer markets.

System 10 also provides private (limited market) links, which are available only to artist/users and industry professionals via virtual manager 13 and premium service feature 15. The private links provide access to non-public markets for artist products and industry services. Both public and private market links as described in more detail with respect to virtual manager 13 in FIG. 2 and premium service feature 15 in FIG. 4, below.

Website 10 distinguishes over previous online musical artist promotions websites in a number of ways. Rather than focusing primarily on consumers, system 10 is directed toward an online community for artists and service providers. Consumer access to system 10 is restricted to public forum links, while the private forum links are limited to artist users and industry professionals.

This approach has several advantages. First, system 10 provides access to public (consumer) markets, but recognizes that consumer sales are only one of many important professional milestones. Thus system 10 is not limited to marketing music, videos and other multimedia artistic works, but is directed toward broader professional opportunities that also include continued training, live performances, and recording contracts.

System 10 also provides professional opportunities for both artists and industry professionals. In particular, system 10 is directed toward forming partnerships between individual artists and the particular industry professionals who can best help them complete the steps on the pathway to reach their career goals and professional milestones. Finally, rather than promoting existing songs and artistic works, website 10 is directed toward helping artists develop additional works by honing their performance, production and marketing skills, and increasing the range of professional opportunities available to them.

While this approach has significant advantages for both artists and industry professionals, it also raises a number of difficult technical questions. These are described below with respect to the particular elements of website and system 10, including virtual manager 13, online studio 14, and premium service feature 15.

FIG. 2 is a schematic illustration showing nonlinear professional development tool or “virtual manager” 13 for online artist promotion and development system 10. Virtual manager 13 is a nonlinear navigational application for professional development, which uses artist history 21 to guide user along development steps 22 toward educational or professional milestones 18.

Virtual manager 13 utilizes input from user/artist GUI 11 and industry/service provider GUI 12, each of which is described above. In particular, user/artist GUI 11 allows the artist or other user to enter input including artist history 21 and other input directly related to steps 22 and milestone 18, such as individual career goals and preferences. Similarly, industry/service provider GUI 12 allows industry professionals to enter input related to development steps 21 and milestones 18, such as service descriptions, business contact information, and individual advice from industry professionals with genre-specific experience.

Artist history 21 is typically provided via an initial artist questionnaire, which is obtained via artist GUI 11 when the user originally signs up for service from system 10. The questionnaire provide artist history 21 with specific information about milestones 18 and development steps 20 that the particular artist has already achieved, and, in some embodiments, career goals that the artist would like to achieve in the future.

The artists' individual preferences are related both to development steps 21 and professional milestones 18. Individual preferences include, for example, a preference for continued study as opposed to live performance, for part-time as opposed to full-time professional opportunities, for national touring as opposed to local performances, or for private recording sessions with full artistic control, as opposed to a professional recording contract with limited artistic control.

Industry input is also related to both steps 20 and milestones 18. Typically, the industry input includes contact information for a range of service providers related to each step 20, and each milestone 18. In some embodiments, virtual manager 13 sorts links to industry professionals according to relevant service provider information, such as geography, pricing information and genre-specific experience.

In these embodiments, the user typically provides related background information to virtual manager 13 via artist GUI 12, including geographical and biographical information used to sort the links, and help partner the artist/user with particular service providers that can efficiently and effectively help them achieve development steps 22 and reach milestones 18. In these embodiments, the background information is provided either via artist history 21 (as part of the questionnaire), or in “real time” as particular steps 22 and milestones 18 are suggested, via artist GUI 11.

Virtual manager 14 is a non-linear, continuously evolving and highly individualized navigation tool, which distinguishes from existing professional development tools in a number of important ways. First, while development steps 22 are described in terms of a particular career path toward professional milestones 18 (that is, a “Road to the Red Carpet”), system 10 is designed around the idea that not all artists take exactly the same path.

For any given professional milestone 18, that is, virtual manager 13 proposes a number of different development steps 22, based both on artist history 21 and input from experienced moguls and industry professionals, as provided via industry GUI 12. Typically, steps 22 are standardized for a typical artist to achieve typical milestones 18. In contrast to linear professional development applications, however, in which steps 22 must be completed in a particular order, virtual manager 13 accounts for steps and milestones already indicated in artist history 21, and, in some embodiments, further modifies steps 22 based upon genre-specific industry input.

Virtual manager/nonlinear development tool 13 thus provides a range of different potential steps and milestones to each artist, rather than a sequential list of steps along a “generic” career path. Virtual manager 14 recognizes that some milestones are not appropriate for all genres, nor for all individual artists in a particular genre. Typical artists view online distribution, live performance and a paid recording contract each as important milestones. Other artists, however, prefer to record and engineer their own work, and distribute music in online digital data form only. Other artists prefer to perform live, only, and do not necessarily distribute recorded performances in any format at all.

In addition to linking artist (users) with particular industry professionals (service providers), virtual manager 13 also provides alternative “do-it-yourself” options via a series of multimedia “how to” guides. Typically, the guides are generated as multimedia works by service providers, and are variously provided for free, as part of a standard paid package (as described with respect to FIG. 4, below), or on a fee-per-use basis. The multimedia how-to guides, provide online, real-time guidance, including, but not limited to, interview and audition tips, instructions for using virtual studio 14 and other multimedia recording equipment, and other specific training and educational material related to particular professional milestones 18 and development steps 22. Each individual user, furthermore, is free to take the recommended path (that is, reach milestone 18 via the suggested steps 22), or request an alternate path based on particular artists preferences, including those described above.

Artists also have access to individualized industry input via industry GUI 12. Depending upon the level of service required, industry input ranges from basic genre-specific advice (hip-hop and pop artists are not directed to the same venues and studios, for example), to individualized, hands-on attention from well-known industry moguls and producers, who use industry GUI 12 to advise, counsel, and provide services to individual artists based upon an internal “hand-picked” rating system provided by premium service application 15 (see FIG. 4).

Artist history 21 is updated according the particular steps 22 chosen by the artist, and virtual manager 13 updates the recommendation. In contrast to standard development tools, however, artist history 31 and virtual manager 13 each account for both unitary (or “one-time”) steps and milestones (such as hiring a single manager at any given time), and plural (or “multiple”) steps and milestones, such as booking a number of gigs and other live performances, which allow the artist to achieve particular goals with greater success.

In further contrast to previous development systems, industry input provided by industry GUI is non-static. Digital media, for instance, undergo rapid evolution, and this evolution is reflected in the recommendations made by virtual manager 13. As a result, artists seeking a career goal of for-profit music sales are guided not only toward traditional digital media like CDs (compact digital discs) and DVDs (digital video discs or digital versatile discs), but also toward distribution via MP3 (MPEG-1, Audio Layer 3, a protocol from the Moving Picture Experts Group) and other streaming data formats such as AAC (advanced audio coding) or WMA (Windows® media audio), which are suitable for a range of different devices including personal computers, iPod® players, cellular phones, and other non-traditional music and multimedia devices. Virtual manager 13 also uses input from industry GUI 12 to suggest up-to-the-date development steps 22 related to digital data management, based both on evolving security concerns and marketing forces that drive the choice between protected files and open distribution.

While system 10 takes user preferences and individual career goals into account, moreover, in some cases virtual manager 13 recommends milestones 18 and development steps 22 that are not among those contemplated by the artist. For many artists, that is, their career goals coincide with appropriate professional milestones 18, and these artists simply use virtual manager 13 to guide them toward the particular steps 22 needed to achieve these goals.

Other artists have career goals that are not realistically attainable based upon a particular artist history 21. If an inexperienced artist seeks a paid recording contract, for example, virtual manager 13 typically suggests alternate milestones 18, such as booking a paid gig or performance venue, and alternate development steps 22, such as hiring a manager. Other artists seek live performance opportunities, but virtual manager 14 sometimes suggests additional preliminary development steps 22, such as additional performance training or hiring backup performers, including studio musicians or dancers. Still other artists have already recorded tracks and seek online distribution systems, but virtual manager 14 sometimes suggests re-engineering the performances to improve quality, or producing a multimedia performance and artist biography for broadcast application 19 (see FIG. 1), in order to more effectively market the artist's other music products.

Virtual manager 13 also provides real-time capability in the event of unforeseen circumstances such as illness or other unavailability before a scheduled performance. Under these circumstances, it is possible to ask virtual manager 13 to suggest a number of backup performers, screen them for availability by geographical area and time schedule, and provide multimedia “demo” performances (that is, commercial works or advertisements) in order to evaluate suitability for a particular genre and performance style. System 10 also allows users to peruse the public forum links for talent, but virtual manager 13 provides significantly greater capabilities than these previous approaches to what is a relatively common problem for many professional performance artists.

These features emphasize the non-linear aspects virtual manager 13, which accommodate a range of individual artists with different views of commercial and professional success. In particular, virtual manager 13 does not require a standard “one-size-fits all” professional development path, but provides individualized guidance toward a particular set of steps 22 based on continuously evolving aspects of artist history 31, input from industry GUI 12, and changing artist preferences as expressed by artist GUI 11.

FIG. 3 is a schematic illustration showing online studio 14 and multimedia/artist biography broadcast application (MM/bio app) 19 for online artist promotion and development system 10. Users utilize artist GUI 11 to upload multimedia (MM) performance 31 and input artist biography 32. MM/bio app 19 combines performance 31 and biography 32 into a combined multimedia/biography program, and broadcasts the combined program to artist GUI 11, industry GUI 12, and to consumers (members of the public) via website/online system 10.

Multimedia performance 31 is a music video, dance video or other multimedia (audio/visual) performance. To create performance 31, each artist needs a minimum artistic and audio/visual engineering capability. Some artists already have access to the necessary musicians, instruments and sound production equipment, possess the technical skill required to use it, and have the resources to hire additional required musicians, dancers, and actors, and these artists are capable of producing performance 31 independently. Typically, however, performance 31 is identified as a milestone via the virtual manager, and is developed in a number of steps by partnering the artist with a range of industry professionals including performance coaches, instrumental rental agents, makeup and costume artists, recording engineers, producers and other service providers. The virtual manager accomplishes this via public and private forum links between artist GUI 11 and industry GUI 12, as described above.

Alternatively, some artists choose to use online studio 14 to produce multimedia performance 31. For these artists, online studio 14 fulfills a number of service provider roles, at a professional level that is appropriate for both entry-level and sophisticated do-it-yourself artists. Online studio 14 is thus appropriate both for artists without the economic resources for full-service production assistance, and for artists who choose not to hire professional assistance in order to save time or to retain artistic control over performance 31.

Online studio 14 is an online (net-based) multimedia application that provides real-time recording, mixing, and editing capability in an easy-to-use, self-instructed format, without requiring specialized equipment or knowledge. In some embodiments, online studio 14 also provides a downloadable (local) studio application, which allows asynchronous recording and later upload to system 10 via artist GUI 11.

In typical applications, online studio 14 provides each artist with everything necessary to produce performance 31. In particular, online studio 14 provides a keyboard interface for virtual studio instruments, including guitar, bass, and other stringed instruments; piano, drums and other percussion instruments; and flutes, horns, saxophones, and other brass, woodwind and reed instruments. In other applications online provides for real-time online interactions with industry professionals, including studio musicians and production engineers, who help the artist produce multimedia performance 31.

Once a music video or other multimedia performance 31 is produced, it is uploaded via artist GUI 11. Typically, upload is performed via an “add multimedia” or other simple command, which is directed toward an electronic copy of the performance. System 10 and artist GUI 11 are compatible with a number of common multimedia data formats, including, but not limited to, WMV (Windows Media Video, a proprietary Microsoft Windows® format), MP3/WMV (combining MPEG-3 with WMV capability), MP4 (MPEG-4 Part 14), AVI (audio/video interleave, in either proprietary Microsoft Windows® format or Matrox OpenDML/AVI 2.0 format), and QuickTime (a proprietary Apple® format).

After upload, a file containing multimedia performance 31 is internally tagged as either a song (audio file) or video (audio-video file), and converted to a standard streaming digital format. In typical embodiments, the streaming format has a widely available or free player application, such as SWF (Adobe® Shockwave Flash®) or FLV (FLash® Video), which are both available from Adobe®. Alternatively, performances produced via online studio 14 will automatically be available in the standard streaming digital format, without the need for upload and format conversion.

To produce biographical information (or artist bio) 32, each artist requires a minimum promotional writing ability and the photographic skills and equipment necessary to produce a simple headshot, band portrait, or other pictorial representation of the artist. In practice, artist bio 32 is created via artist GUI 12, using a simple administrative application such as a “New Artist Bio” or similar function. The function arranges biographical information in any of a number of formats, including, but not limited to, platform-independent WYSIWYG editors based upon TinyMCE, an open-source Javascript editor released by Moxiecode Systems AB.

Again, some artists are capable of producing artist biography 32 at the desired level of professional ability, while others are not. Moreover, simple biographies that are sufficient for a beginning artist are typically updated as the artist develops, and attains new professional milestones. As with respect to multimedia performance 31, system 10 accommodates both “do-it-yourself” artists and those seeking additional assistance from industry professionals, in order to produce artist biography 32 at the desired level of professionalism and style. For these artists, the virtual manager suggests a range of appropriate industry professionals, including photographers, marketing professionals, and other service providers.

In one embodiment, broadcast application 19 combines performance 31 and artist bio 32 into a program via an administrative application such as a playlist administrator. In alternate embodiments the playlist administrator is a distinct from broadcast application 19, but performs analogous functions.

The playlist administrator assigns the combined multimedia performance/artist bio program to a genre or genres, and broadcast application 19 broadcasts the program via system 10. The program is broadcast at a given time or within a given play block, as assigned to each genre. The genres thus define a number of different “channels” or program lists, in which the programs are provided by broadcast application 19.

More specifically, broadcast application 19 streams multimedia performance 31, while simultaneously “scrolling” or displaying artist biography 32. In typical embodiments, performance 31 is streamed in one window or application, while artist bio 32 is simultaneously scrolled or displayed in another window or application. In some of these embodiments, particular elements of artist bio 32 are coordinated with particular elements of performance 31, such as a photographic element of bio 32 combined with the opening bars or closing credits of performance 31, or a particular trivia element of artist bio 32 combined with an associated phrase or theme in performance 31. In other embodiments, artist bio 32 is continuously scrolled during streaming of performance 31, without coordinating or associating elements.

Online studio 14 and broadcast application 19 are also available to industry professionals via industry GUI 12. For service providers, multimedia performance 31 represents a commercial work, and artist biography 32 represents service provider information including business name, service descriptions and genre-specific experiences, and contact information. System 10 thus allows industry professionals to produce commercial programs and “how-to” informational programs for broadcast via broadcast application 19. Each commercial or informational program is assigned to a playlist by genre (or “channel”), just as the artistic programs are, allowing broadcast application 19 to interweave artistic, informational, and commercial content.

Online studio 14 and broadcast application 19 illustrate the flexibility of system 10 in helping each artist navigate an individual path though the various developmental steps required to attain professional milestones. These elements also illustrate that while artists and industry professionals are nominally quite different, they share important attributes, and both benefit from participation in the online community-based methods of system 10. This provides significant advantages over existing artist promotion and development systems, which do not help artists develop more marketable products, and do not recognize that service providers and other industry professionals have as much to gain from the online community as the artists themselves. These advantages are further enhanced by premium service capability, as described immediately below.

FIG. 4 is a schematic illustration showing premium service feature 15 for online artist promotion and development system 10. In this particular example, premium service feature 15 is “The Vault” or another analogous premium service feature, which provides the highest possible level of premium services. In other embodiments premium services are allocated according to individual artist/user service levels, including, but not limited to, free service, bronze service, silver service, gold service, “The Vault,” and other free or premium service level identifiers.

As embodied in FIG. 4, premium service feature 15 provides at least three substantial services. First, premium service feature 15 provides “internal” or non-public artist ratings 20A for artists and internal industry ratings 20B for industry professionals, respectively, via internal rating function 41. Second, premium service feature 15 provides non-public (private) forum and market links for rated artist and industry professionals, which are not available to non-rated, non-premium-level artists. Third, premium service feature 15 also provides hands-on, individualized career guidance to premium-level artists, via industry input from industry moguls, well-known producers and promoters, and other internally-rated industry professionals.

Rating function 41 is distinguished from public ranking, voting, and other public ratings, which are subject to “ballot stuffing,” voter manipulation, and other non-substantive effects unrelated to artistic merit and professional expertise. Internal rating function 41 is not public, and is protected from standard ballot-stuffing attempts. Each artist, for example, is allowed to rate each other artist and each industry professional only once. Fans and other consumers (that is, members of the general public) are not provided access to internal rating function 41 at all.

In typical embodiments, only some industry professionals, including internally-rated industry professionals, are allowed to rate artists and other industry professionals, while other industry professionals are denied access to internal rating function 41. Rated industry professionals, moreover, do not contribute to internal rating function 41 in the same way that artists do. In particular, rated industry professionals do not necessarily numerically rate artists and other industry professionals. Instead, rated industry professionals provide a gateway for internal ratings, such that each internally rated artist and industry professional is subject to subjective criteria for individual selection, in addition to the objective numerical (internal) rating provided by the artists.

As a result, rating function 41 provides a number of “hand-picked” up-and-coming artists judged to have significant professional potential, via internal artist rating 20A, and a number of industry professionals judged to have significant industry expertise, via internal professional rating 20B. In some embodiments internal ratings 20A and 20B are genre-specific, and in other embodiments certain artists and industry professionals are judged to have sufficient merit to receive “global” or non-genre-specific ratings.

Premium-level artists have access to these internal ratings, which allows them to more effectively screen service providers, and select from those judged by both other artists and industry professionals to be the experienced, talented, and qualified. Enhanced or premium service feature 15 also allows the virtual manager to provide enhanced service, by screening service providers according to internal ratings as well as genre, geographical, and pricing information.

Internal artist rating 20A is also used to provide non-public (private) forum links between “A-list” industry professionals who are industry leaders and moguls, and rated artists who are judged to have significant professional potential. Premium service feature 15 thus provides private market opportunities to rated artists and rated industry professionals, which are not available to non-rated artists and non-rated service providers.

Some industry professionals are in high demand and are not publicly listed (that is, they do not appear on public links). These industry professionals prefer to work with hand-picked artists, and typically make a combination of economic, professional and personal decisions about which particular artists will most benefit from their services. Premium service feature 15 provides rated (hand-picked) artists with access to these “A-list” or premium industry leaders, giving them additional non-public market opportunities including, but not limited to, endorsements, non-public distribution networks, non-publicly available recording and promotional services, and performance contracts with “A-list” promoters and producers. Similarly, premium service feature 15 also provides rated industry professionals with private market opportunities to provide services to rated artists, which are not available to non-rated service providers.

Typically, artists pay for vault access, while providers are hand-selected. In these embodiments, artists with sufficient talent to be internally rated benefit the most from the service, but there are still important advantages for artist who are not rated. In particular, premium service feature 15 provides any artist, rated or not, with access to individual, hands-on professional guidance from both rated and “A-list” (not publicly listed) industry professionals. To the extent that the artist's goals are include artistic development, this enhanced level of service has inherent advantages, regardless of eventual commercial success. The enhanced level of service also provides more individualized and detailed development steps and more specific recommendations regarding particular industry service providers, which can make commercial success a more obtainable goal.

FIG. 4 also illustrates the value of public forum links to artist market 42 and service provider market 43. The public market links allow artists and industry professionals to buy and sell products and services independently of The Vault or other premium service feature 15. Publicly available genre-specific artist directories and genre-specific program broadcasts, for example, provide public access to artist market 42, in order to sell music and performance-related products to consumers in the general public. Public market opportunities include both the opportunity for live performance and the opportunity to market audio or multimedia works and performance-related merchandise. System 10 is compatible with the distribution of a wide range of media formats, including “media-less” (downloadable) formats such as MP3, AAC or WMA (Windows® media audio), as well as traditional digital formats including CDs, DVDs, DATs (digital audio tapes), and analog audio formats including cassette tapes and vinyl-based album products such as LPs (long-playing albums).

Public forum links also provide public access to provider market 43, allowing artists and industry professionals to create professional relationships related to specific developmental steps and professional milestones. In essence, system 10 markets the artist to the service providers, via their multimedia performances, and in turn markets the industry professionals to the artists, via the virtual manager as described with respect to virtual manager 13 in FIG. 3, above.

The public forum links also provide public access to consumers who do not happen to be performance artists, but nonetheless seek industry-related services. These include consumers seeking to book venues for a private performance, or seeking photographic or other industry-related services for non-performance purposes.

The present invention has been described with reference to preferred embodiments. The terminology used is for the purposes of description, not limitation, and workers skilled in the art will recognize that changes may be made in form and detail without departing from the spirit and scope of the invention.

1. A system for online artist promotion, the system comprising:
an artist interface for artists to input artist histories and artist biographies, and to upload multimedia performances;
a broadcast application for broadcasting the multimedia performances;
an industry interface for industry professionals to input service provider information; and
a virtual manager for guiding the artists through development steps as a function of the artist history, and to link the artists with the industry professionals as a function of the development steps and the service provider information.

2. The system of claim 1, wherein the broadcast application broadcasts the multimedia performances as programs by simultaneously streaming the multimedia performances and scrolling the artist biographies.

3. The system of claim 1, wherein the artist interface further allows artists to select genre tags.

4. The system of claim 3, wherein the broadcast application broadcasts the programs over a number of genre-specific channels.

5. The system of claim 3, wherein the virtual manager further links the artists with industry professionals as a function of the genre tags.

6. The system of claim 1, further comprising an online studio for generating the multimedia performances via a real-time link with the artists via the artist interface.

7. The system of claim 6, wherein the online studio provides the artist with access to virtual instruments for generating the multimedia performance.

8. The system of claim 7, wherein the online studio further generates the multimedia performance via a real-time link with an industry professional via the industry interface.

9. The system of claim 1, further comprising a premium service feature for rating artists and industry professionals, and for providing private links between rated artists and rated industry professionals.

10. The system of claim 1, wherein the premium service feature further provides the artists with individual, hands-on professional guidance from rated industry professionals.

11. The system of claim 1, further comprising a website that provides the artist interface, the broadcast application, the industry interface, and the virtual manager.

12. A website for professional artist development, the website comprising:
a first graphical user interface for providing an artist history, an artist biography and a multimedia performance;
a broadcaster for broadcasting the multimedia performance;
a second graphical user interface for providing industry input; and
a non-linear development tool for suggesting professional development milestones as a function of the artist history and the industry input.

13. The system of claim 12, wherein the broadcaster broadcasts the multimedia performance as a program in combination with the artist biography.

14. The system of claim 12, wherein the non-linear development tool further suggests developmental steps required to accomplish the professional milestones.

15. The system of claim 14, wherein the industry input comprises individualized career guidance related to the artist history, the milestones, and the developmental steps.

16. The system of claim 14, further comprising a vault for preferred subscribers, and wherein the non-linear development tool further suggests the developmental steps as a function of internal rankings provided by the vault.

17. The system of claim 13, further comprising an online studio that provides virtual instruments for generating the multimedia performance.

18. A method for promoting and developing performance artists, the method comprising:
providing a website with an artist interface, an industry interface, a broadcast application and a professional development tool;
receiving an artist history, an artist biography, and an artist performance from the performing artists via the artist interface;
broadcasting the artist performance and the artist biography in order to promote the artists to a public market;
receiving industry input and service provider information via the industry interface; and
guiding the performance artists down a career path as a function of the artist history, the industry input, and the service provider information.

19. The method of claim 18, wherein guiding the performance artists down a career path comprises linking the performance artists to the industry interface as a function of the career path and the service provider information.

20. The method of claim 18, further comprising providing an online studio for producing the multimedia performance via the artist interface.
